(19) United States
(12) Patent Application Publication
(10) Pub. No.: US 2022/0181720 A1
(43) Pub. Date: Jun. 9, 2022

(54) BATTERY MODULE WITH A PLURALITY OF ELECTROCHEMICAL ACCUMULATORS, COMPRISING A NEBULIZER DEVICE FOR SPRAYING MICRODROPLETS IN THE EVENT OF THERMAL RUNAWAY OF AT LEAST ONE OF THE ACCUMULATORS

(71) Applicant: COMMISSARIAT A L'ENERGIE ATOMIQUE ET AUX ENERGIES ALTERNATIVES, Paris (FR)

(72) Inventors: Rémi VINCENT, Grenoble Cedex 09 (FR); Hadrien LAMBERT, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/643,022

(22) Filed: Dec. 7, 2021

(30) Foreign Application Priority Data
Dec. 8, 2020 (FR) 20 12861

(51) Int. Cl. H01M 10/6569; H01M 10/0525; H01M 4/48; H01M 10/613; H01M 10/625; H01M 10/63; H01M 50/249

(52) U.S. Cl. CPC H01M 10/6569; H01M 10/0525; H01M 4/483; H01M 2220/20; H01M 10/625; H01M 10/63; H01M 50/249; H01M 10/613

(57) ABSTRACT

A nebulizer may be into in a battery module, the nebulizer being configured to atomize a liquid, preferably water, contained in a tank, above a threshold temperature characteristic of a thermal runaway, the microdroplets thus created being sprayed within the module to absorb the energy created by the thermal runaway.

### TECHNICAL FIELD

The present invention relates to the field of electrochemical accumulators, and more particularly metal-ion accumulators.

The invention aims primarily to optimize the cooling of the accumulators of a battery module such that the energy from a thermal runaway from a given accumulator within the module cannot be propagated to the other accumulators of the module.

Although described with reference to a lithium-ion accumulator, the invention applies to any metal-ion electrochemical accumulator, that is to say also the sodium-ion, magnesium-ion, aluminum-ion and other such accumulators, or, more generally, to any electrochemical accumulator.

A battery module according to the invention can be onboard or stationary. For example, the fields of electric and hybrid transport and the storage systems connected to the network can be considered in the context of the invention.

### PRIOR ART

As illustrated schematically in FIGS. 1 and 2, a lithium-ion battery or accumulator normally comprises at least one electrochemical cell consisting of an electrolyte component 1 between a positive electrode or cathode 2 and a negative electrode or anode 3, a current collector 4 connected to the cathode 2, a current collector 5 connected to the anode 3 and, finally, a packaging 6 arranged to contain the electrochemical cell tightly while being passed through by a part of the current collectors 4, 5.

The architecture of the conventional lithium-ion batteries comprises an anode, a cathode and an electrolyte. Several types of geometry of conventional architecture are known:
a cylindrical geometry as disclosed in the patent application US 2006/0121348,
a prismatic geometry as disclosed in the patents U.S. Pat. Nos. 7,348,098, 7,338,733;
a stacked geometry as disclosed in the patent applications US 2008/060189, US 2008/0057392, and the patent U.S. Pat. No. 7,335,448.

The electrolyte component 1 can be in solid, liquid or gel form. In this last form, the component can comprise a separator made of polymer, of ceramic or of microporous composite soaked with organic electrolyte or electrolytes or of ionic liquid type which allows the displacement of the lithium ion from the cathode to the anode for a charge and in reverse for a discharge, which generates the current. The electrolyte is generally a mixture of organic solvents, for example carbonates to which is added a lithium salt, typically LiPF6.

The positive electrode or cathode 2 is composed of lithium cation insertion materials which are generally composite, like LiFePO₄, LiCoO₂, LiNi_{03.3}Mn_{0.33}Co_{0.33}O₂.

The negative electrode or anode 3 is very often composed of graphite carbon or of Li₄TiO₅O₁₂ (titanate material), possibly also based on silicon or composite formed based on silicon.

The current collector 4 connected to the positive electrode is generally made of aluminum.

The current collector 5 connected to the negative electrode is generally made of copper, of nickel-plated copper or of aluminum.

A lithium-ion battery or accumulator can obviously comprise a plurality of electrochemical cells which are stacked on top of one another.

Traditionally, a Li-ion battery or accumulator uses a pair of materials on the anode and the cathode allowing it to operate at a high voltage level, typically equal to 3.6 volt.

Depending on the type of application targeted, the aim is to produce either a thin and flexible lithium-ion accumulator or a rigid accumulator: the packaging is then either flexible or rigid and in the latter case constitutes a kind of housing.

The flexible packagings are usually manufactured from a multilayer composite material, composed of a stacking of aluminum layers covered by one or more polymer films laminated by bonding.

The rigid packagings are, for their part, used when the applications targeted are restrictive where a long lifetime is sought, with, for example, much higher pressures to be withstood and a stricter required tightness level, typically less than 10⁻⁸ mbar.l/s, or in highly restrictive environments such as the aeronautic or space field.

Also, to date, a rigid packaging used is composed of a metal housing, typically made of stainless steel (316L or 304 stainless steel) or of aluminum (Al 1050 or Al 3003), or even of titanium.

The geometry of most of the rigid Li-ion accumulator packaging housings is cylindrical, because most of the electrochemical cells of the accumulators are wound by winding according to a cylindrical geometry around a cylindrical mandrel. Prismatic forms of housings have also already been produced by winding around a prismatic mandrel.

The patent application FR3004292 describes the use of the interior of the mandrel as air blade for providing core cooling for a wound cell of a metal-ion accumulator.

One of the types of rigid housing of cylindrical form, normally manufactured for a high-capacity Li-ion accumulator, is illustrated in FIG. 3.

A rigid housing of prismatic form is also shown in FIG. 4.

The housing 6 comprises a cylindrical lateral jacket 7, a bottom 8 at one end, a cover 9 at the other end, the bottom 8 and the cover 9 being assembled with the jacket 7. The cover 9 supports the current output poles or terminals 4, 5. One of the output terminals (poles), for example the negative terminal 5, is welded onto the cover 9 while the other output terminal, for example the positive terminal 4, passes through the cover 9 with the insertion of a seal, not represented, which electrically insulates the positive terminal 4 from the cover.

The type of rigid housing widely manufactured consists also of a stamped bucket and a cover, welded together on their periphery. On the other hand, the current collectors comprise a bushing with a part protruding on top of the housing and which forms a visible terminal, also called pole, of the battery.

A battery pack P consists of a variable number of accumulators numbering up to several thousand which are linked electrically in series or in parallel to one another and generally by connecting bars, normally called busbars.

An example of battery pack P is shown in FIG. 5. This pack consists of two modules M1, M2 of Li-ion accumulators A that are identical and linked to one another in series, each module M1, M2 consisting of four rows of accumulators linked in parallel, each row consisting of six Li-ion accumulators.

As represented, the mechanical and electrical connection between two Li-ion accumulators of one and the same row is produced by screwing busbars B1, advantageously made of copper, each linking a positive terminal 4 to a negative terminal 5. The connection between two rows of accumulators in parallel in one and the same module M1 or M2 is ensured by a busbar B2, also advantageously made of copper. The connection between the two modules M1, M2 is ensured by a busbar B3, also advantageously made of copper.

In the development and the manufacture of the lithium-ion batteries, for each profile/new request, regardless of the market actors, that requires accurate dimensioning (series/parallel electrical architectures, mechanical and thermal architectures, etc.) to optimally design a powerful and safe battery pack.

In particular, the safety of the lithium-ion accumulators must be taken into consideration equally at the accumulator, module and battery pack levels. Safety is, moreover, an increasingly important criterion, especially when the battery systems are destined for use by the public, in fields like aviation or transport by land vehicle.

The need to be able to improve, even guarantee, the safety of the accumulators and battery modules is therefore becoming a critical issue.

Various passive or active devices with a safety function can be incorporated in a cell (accumulator), and/or a module and/or the battery pack to prevent the problems, when the battery is in so-called abusive operating conditions.

A lithium electrochemical system, whether it be on the scale of a cell (accumulator), module or pack, produces exothermic reactions regardless of the cycling profile given. Thus, on the unitary accumulator scale, based on the chemistries considered, the optimal operation of the lithium-ion accumulators is limited within a certain temperature range.

An electrochemical accumulator must operate within a defined temperature range, typically generally less than 70° C. on its outer housing surface, under penalty of degrading its performance levels, even physically degrading it to destruction.

An example that can be cited includes the lithium accumulators of iron-phosphate chemistry which have an operating range that lies generally between −20° C. and +60° C. Above 60° C., the materials can undergo significant degradations reducing the performance levels of the cell. Above a so-called thermal runaway temperature that can lie between 70° C. and 110° C., internal exothermic chemical reactions begin. When the accumulator is no longer capable of sufficiently discharging heat, the temperature of the cell increases to destruction, this phenomenon being designated normally as thermal runaway.

In other words, a thermal runaway occurs in a cell (accumulator) when the energy released by the exothermic reactions which occur inside the latter exceeds the outward dissipation capacity. This runaway can be followed by a generation of gas and explosion and/or fire. The rapidly increasing provision to the public of battery systems will generate incorrect uses of the systems, which will be reflected by mechanical strains, poor electrical or thermal management, etc. These incorrect uses will probably in turn cause thermal runaways of one or more accumulators within a module or a battery pack.

Various solutions have been proposed to limit or avoid the propagation of a thermal runaway within a battery pack.

An example that can be cited is the patent EP2181481B1 which describes a method for limiting the propagation of a thermal runaway in a battery block with multiple accumulators.

FR3045793B1 describes a battery pack cooled by a phase-change material in a hermetically sealed chamber at constant pressure, the material being capable of changing from liquid phase to vapor phase.

The patent application DE102013017396A1 describes a battery module in which a boiling heat-transfer liquid is directly in contact with the cells of the module, in order to control the temperature and keep it within a predetermined temperature range.

The different solutions according to the prior art do not make it possible simply to actually mitigate a thermal runaway of an accumulator within a battery pack, that is to say either to calm the start of a runaway by increased cooling, or make it possible to attenuate the transmission of the energy dissipated by a thermal runaway of the accumulator to the other accumulators of the pack, in order to prevent them from entering into a thermal runaway situation.

There is therefore a need to improve the battery pack cooling solutions, notably in order to absorb the energy dissipated by a thermal runaway of a given accumulator within the pack and thus limit the temperature of the other accumulators of the pack and thereby prevent these other accumulators from also beginning thermal runaway.

Furthermore, the improvement must also be optimized in terms of weight and bulk to preserve the performance levels of the pack.

The aim of the invention is to at least partly address such need or needs.

### SUMMARY OF THE INVENTION

To do this, the invention relates, under one of its aspects, to a battery module comprising:
one or more accumulators each comprising at least one electrochemical cell formed by a cathode, an anode and an electrolyte inserted between the cathode and the anode, a packaging arranged to tightly contain the electrochemical cell;
at least one device forming a nebulizer comprising:

a tank containing a liquid to be nebulized,

at least one piezoelectric element arranged in contact with a surface of the tank,

at least one temperature sensor designed to measure the temperature at a point within the module,

an electronic control unit linked to the temperature sensor and to the piezoelectric element or elements, the electronic unit being adapted to, respectively, detect, from the measurement made by the sensor, a threshold temperature being exceeded and, when the detection is made, electrically power the piezoelectric element or elements such that the latter make(s) the surface of the tank vibrate in order to thus nebulize the liquid into microdroplets sprayed in the module.

“Temperature sensor” is understood here and in the context of the invention to mean a sensor which directly measures the temperature, or any other sensor which measures a physical or chemical parameter which makes it possible to deduce the temperature, like a pressure sensor or a chemical sensor (gas sensor).

Thus, a temperature sensor according to the invention makes it possible to directly or indirectly detect the passage of a temperature within the module above a certain threshold.

A temperature sensor can be a control of a BMS of the module or of a battery pack incorporating the module, which has identified a temperature rise within the module. “Nebulizer” is understood here and in the context of the invention to mean, equally, atomizer, sprayer, atomizer, that is to say a device which makes it possible to transform a liquid into a cloud of extremely fine droplets (mist or fog).

The electronic control unit is preferably electrically powered by at least one of the accumulators of the module. Typically, the electronic unit can be powered by the 12 V voltage of the accumulators.

The electronic control unit can comprise a voltage converter for converting the direct voltage from an accumulator into the power supply voltage of the piezoelectric element or elements.

According to an advantageous embodiment, the electronic control unit comprising two distinct electronic circuits linked to one another by a relay, one of the two circuits being adapted to supply an electrical power supply to the other of the two circuits and detect, from the measurement made by the sensor, a temperature exceeding the threshold temperature, the other of the two circuits being adapted to electrically power the piezoelectric element or elements, the relay being activated when the detection is made.

The module can comprise a plurality of nebulizers. According to this embodiment, the module can then comprise one or more temperature sensors specific to each nebulizer or common to the plurality of nebulizers.

According to another advantageous embodiment, the packaging of each accumulator is a housing, notably of cylindrical format.

According to this embodiment, and an advantageous variant, the nebulizer or nebulizers are each incorporated in a housing of form and dimensions identical to those of an accumulator housing, the nebulizer housing being pierced by at least one through-hole to allow the microdroplets to be sprayed within the module to escape. This incorporation allows the nebulizer to be located in a battery module instead of an accumulator. Thus, it is possible to optimize not only the placement for spraying the microdroplets but also the incorporation of the nebulizer in the design of the module.

According to this variant, the housing of the nebulizer can advantageously be electrically connected in parallel with the housings of the accumulators of the module.

Advantageously, the temperature sensor is a thermocouple, or a pressure sensor or a chemical sensor.

A pressure sensor can advantageously make the detection of a temperature rise, by an increase in the pressure in the compartment of the module.

A chemical sensor can advantageously perform a chemical detection following a thermal degradation of a tracer material in the compartment of the module, which generates the emission of volatile products, such as COV, CO₂. The patent application in the name of the Applicant, filed on 29 Oct. 2020, under the number FR2011112, describes a temperature-sensitive composition which acts as such a tracer material.

The tank can be a tank covered with a film designed to tear under the pressure of the microdroplets.

The piezoelectric element or elements can be disposable. Thus, they are used only for a single nebulization of the liquid contained in the tank.

The piezoelectric element or elements can be configured to make the surface of the tank vibrate for 5 to 10 seconds. After 5 to 10 seconds, the piezoelectric element or elements can deteriorate. In practice, 5 seconds of intense vibration can be sufficient for the nebulization of the liquid.

Thus, the piezoelectric element or elements can operate in an explosive manner, that is to say with a very intense vibration mode for 5 to 10 seconds before failing. Such piezoelectric elements have the advantage of being inexpensive and of small size.

The liquid to be nebulized is preferably water, possibly glycolated and/or de-ionized, or a liquid based on dodecafluorooxepane. More generally, it can be any fire-inhibiting liquid.

Thus, the invention consists essentially in incorporating, in a battery module, a nebulizer configured to atomize a liquid, preferably water, contained in a tank, above a threshold temperature characteristic of a thermal runaway, the microdroplets thus created being sprayed within the module to absorb the energy created by the thermal runaway.

In other words, in the event of a thermal runaway, an accumulator in the module will emit a great quantity of energy, characterized by a rise in the temperature of the module.

At the moment when the threshold temperature is reached, the nebulizer will atomize the liquid from the tank into a fog.

The microdroplets of this fog will be sprayed within the module and absorb the energy upon their change of phase, that is to say when they change from the liquid state to the gaseous state. The energy thus absorbed will make it possible to limit the transmission of energy to the other accumulators of the module.

The liquid used is preferably water because it exhibits one of the best energy absorption rates by change of material state.

The inventors have overcome a technical prejudice according to which water cannot be implemented with electricity to avoid any risk of electrification and of electrocution.

Now, the inventors have made the observation that, in the case of the batteries, the risk of fire is much more dangerous for the users than the electrification through the water which, in addition, is in the form of a vaporized fog.

Thus, they have shrewdly considered a nebulizer as effective means for controlling or avoiding the risk of propagation of the fire upon the thermal runaway of an accumulator, which can occur for example following a mechanical impact, an overvoltage or an overtemperature.

It is specified here that, for the thermal runaway phenomenon, reference will be made to the publication [1] and to the protocol described in that publication. The so-called “self-heating” and “thermal runaway” temperatures are respectively denoted T1 and T2 in that publication.

The temperature T1, typically 70° C., in FIG. 2 of the publication, is the temperature from which the accumulator heats up without an external source at a typical rate of 0.02° C./min in adiabatic conditions.

The temperature T2, typically 150° C., in FIG. 2 of the publication, is the temperature from which the accumulator heats up at a typical heating rate of 10° C./min in adiabatic conditions, which leads to the melting of the separator in the electrochemical bundle of the accumulator, to a short-circuit and therefore to the collapse of the voltage.

“Thermal runaway” can thus be understood here, and in the context of the invention, to be a ratio between the value of the derivative of the heating temperature and that of time at least equal to 0.02° C. per min.

Ultimately, the invention provides numerous advantages, some of which can be cited as follows:
a safety solution that is simple to implement and effective for preventing the propagation of a thermal runaway in a battery module;
a solution which is not detrimental to the weight of a module or of a battery pack, a nebulizer device according to the invention that can be very light, which is highly advantageous for the onboard applications;
the possibility of very rapid and easy placement in a battery module, from design thereof or, on the contrary, in retrofitting an existing module or battery pack.

For an application to a Li-ion battery pack, each accumulator is a Li-ion accumulator in which:
the material of the negative electrode or electrodes is chosen from the group comprising graphite, lithium, titanate oxide Li₄TiO₅O₁₂;
the material of the positive electrode or electrodes is chosen from the group comprising LiFePO₄, LiCoO₂, LiNi_{0.33}Mn_{0.33}Co_{0.33}O₂.

The invention relates also to any vehicle comprising at least one battery module as described previously.

Other advantages and features of the invention will emerge more clearly on reading the detailed description of exemplary implementations of the invention given in an illustrative and nonlimiting manner with reference to the following figures.

### BRIEF DESCRIPTION OF THE DRAWINGS

FIG. 1 is an exploded perspective schematic view showing the different elements of a lithium-ion accumulator.

FIG. 2 is a front view showing a lithium-ion accumulator with its flexible packaging according to the state of the art.

FIG. 3 is a perspective view of a lithium-ion accumulator according to the state of the art with its rigid packaging consisting of a housing of cylindrical form.

FIG. 4 is a perspective view of a lithium-ion accumulator according to the state of the art with its rigid packaging consisting of a housing of prismatic form.

FIG. 5 is a perspective view of a busbar assembly of lithium-ion accumulators according to the state of the art, forming a battery pack.

FIG. 6 is a side view of a battery module according to the invention equipped with a busbar and with a nebulizer device.

FIG. 7 is a side view of an advantageous example of integration of a nebulizer device according to the invention, in a housing of format and dimensions identical to those of an accumulator housing.

FIG. 8 is an electronic diagram of a circuit constituting a part of the electronic control unit of a nebulizer device according to the invention.

FIG. 9 illustrates, in the form of curves, temperature readings as a function of time, respectively of an accumulator cooled by a nebulization according to the invention and of an accumulator according to the state of the art without cooling device.

### DETAILED DESCRIPTION

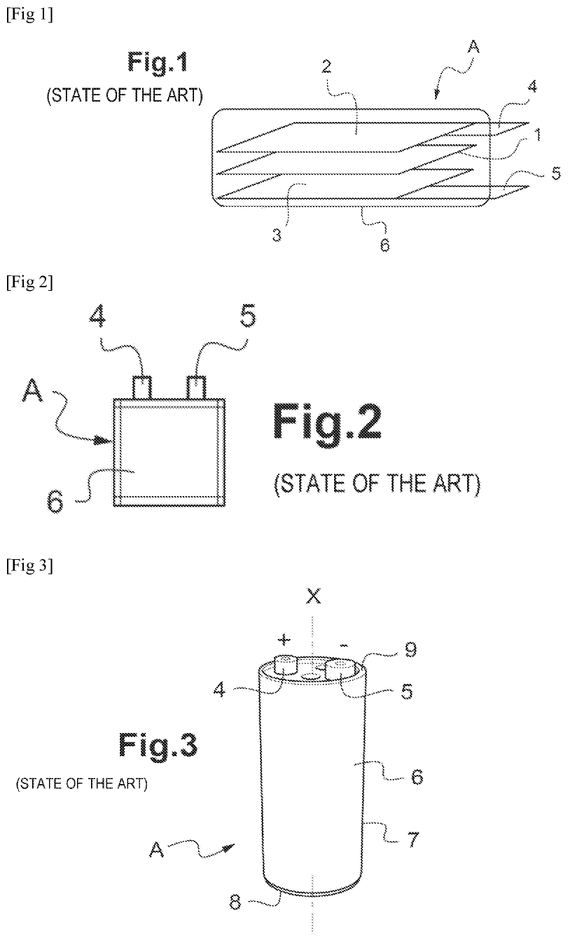

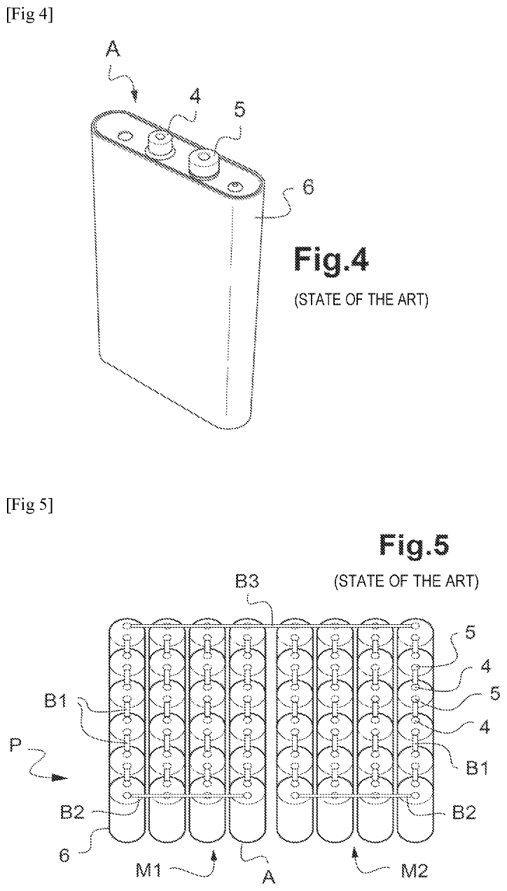

FIGS. 1 to 5 relate to different examples of Li-ion accumulators, flexible packagings and accumulator housings as well as a battery pack according to the state of the art. These FIGS. 1 to 5 have already been commented on in the preamble and will not therefore be discussed further hereinbelow.

For clarity, the same references designating the same elements according to the state of the art and according to the invention are used for all the FIGS. 1 to 9.

Throughout the present application, the terms “bottom”, “top”, “low”, “high”, “below” and “above” should be understood for reference with respect to Li-ion accumulator housings arranged vertically.

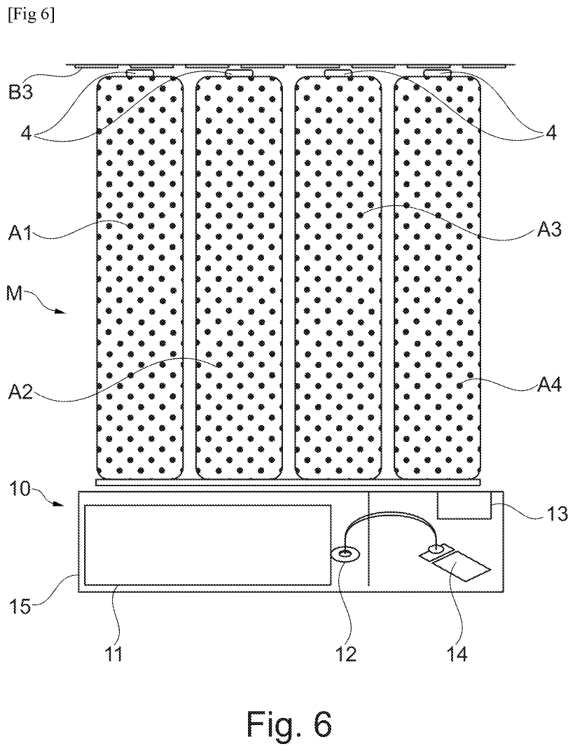

FIG. 6 represents a battery module M of Li-ion accumulators A1, A2, A3, A4 equipped with an example of nebulizer device 10 according to the invention.

In the examples illustrated, the accumulators A1-A4 illustrated can have housings of cylindrical format, typically of 18650 or 21700 format.

The accumulators A1-A4 are linked electrically by their output terminal 4 per group by means of a busbar B3.

The nebulizer 10 first of all comprises a tank 11 containing a liquid to be nebulized, preferably water, possibly glycolated and/or de-ionized.

It also comprises a piezoelectric element 12 arranged in contact with a surface of the tank 11 and a temperature sensor 13, preferably a thermocouple, adapted to measure the temperature at a point within the module M.

The nebulizer 10 finally comprises an electronic control unit 14 linked to the temperature sensor 13 and to the piezoelectric element 12. The control unit 14 is powered electrically directly by the voltage of at least one accumulator, typically at 12 V.

A housing 15 can house all of the abovementioned components 11, 12, 13, 14.

The operation of the nebulizer device 10 is as follows.

When the accumulators are operating, the electronic unit 14 compares, in real time and constantly, the temperature measured by the sensor 13 to a threshold temperature characteristic of a thermal runaway.

The sensor 13 need not be a temperature sensor as such, but a sensor which makes it possible to detect the crossing of the target thermal threshold, such as a pressure sensor or a chemical sensor.

When the measured temperature is above the threshold temperature, then the electronic unit 14 electrically powers the piezoelectric element 12.

The activated piezoelectric element makes the surface of the tank with which it is in contact vibrate. The liquid contained in the tank is then nebulized and the microdroplets which result therefrom are sprayed in the module. The spraying can be done under the effect of the pressure prevailing in the tank by the microdroplets which will pierce a tank sealing film, for example made of plastic.

The microdroplets will absorb the energy from the thermal runaway when they change phase, from the liquid state to the gaseous state. The energy thus absorbed will make it possible to limit the transmission of energy to the other accumulators of the module.

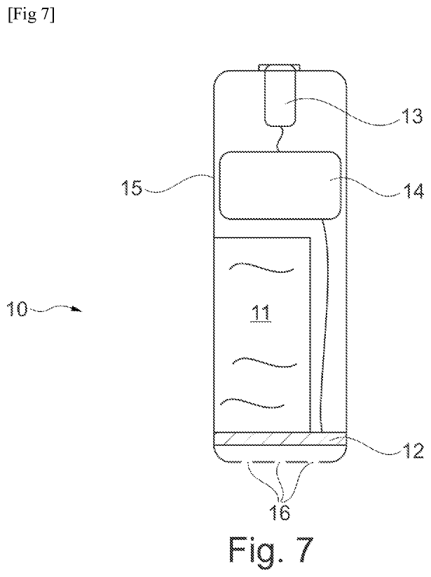

FIG. 7 shows an optimized integration of the nebulizer device 10: the housing 15 has precisely the cylindrical form and the dimensions of a housing 6 of an accumulator A1, A2, A3, A4. Thus, the nebulizer 10 can be located optimally within the module, notably in a zone that is critical with respect to a thermal runaway. It is then preferentially connected in parallel to other accumulators. In this case, a voltage conversion within the nebulizer 10 may be necessary to adapt the voltage from the parallel-connected accumulators to its operating requirements.

The cylindrical housing 15 illustrated is pierced with a plurality of through-holes 16 to allow the microdroplets of the liquid to pass into the environment of the module.

The electronic control unit 14 can consist of two distinct electronic circuits linked to one another by a relay, one of the two circuits being adapted to supply an electrical power supply to the other of the two circuits, read the temperature measured by the sensor 13 and compare it with the threshold temperature, the other of the two circuits being adapted to electrically power the piezoelectric element 12, the relay being activated when the compared temperature is above the threshold temperature.

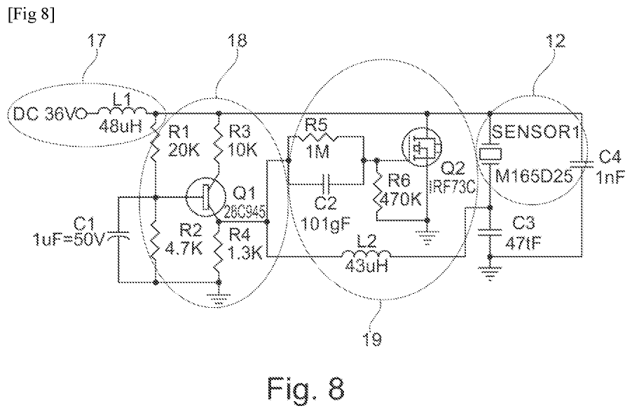

FIG. 8 illustrates an example of electronic circuit dedicated to the powering of the piezoelectric element 12. The set of electronic components is not detailed here exhaustively, only the subfunctions being so detailed.

The electronic circuit comprises, respectively from the input to the output, an input 17 with a current smoothing inductance, a voltage matching subcircuit 18 for powering the piezoelectric element, and a resonance subcircuit 19.

The inventors carried out tests to validate the operation of the nebulizer device 10 according to the invention.

These tests consist in heating up an accumulator very rapidly, then in injecting a water cloud into the surrounding atmosphere.

More specifically, they heated up an accumulator of 18650 format to a temperature of 60° C., constantly with a current with a value equal to 6 A.

Then, they injected a water cloud into the atmosphere of the accumulator. They then observed a lowering of temperature of the accumulator of 8° C. with a stabilization at 52° C.

Thus, in order to reestablish the initial temperature of 60° C., the heating power was increased by changing the power supply current from 6 A to 7.5 A.

Following the heating of an accumulator to 160° C., its rate of cooling in the open air, that is to say according to the state of the art without cooling device, or in a nebulization mist, that is to say according to the invention, was measured.

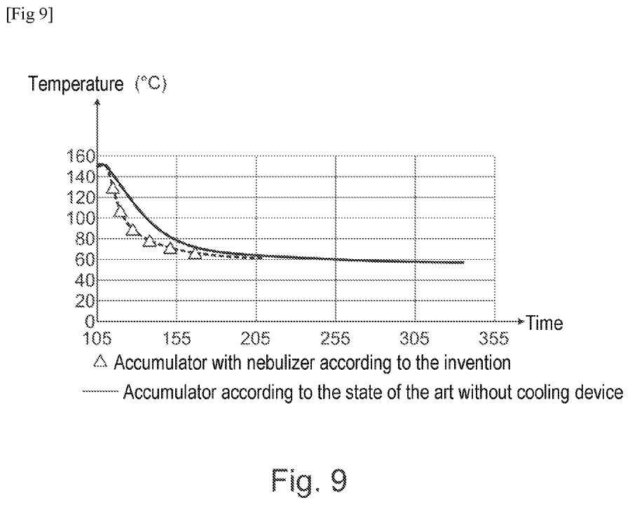

FIG. 9 presents temperature trend curves during a thermal runaway test implemented respectively with an accumulator provided with a nebulizer device according to the invention and an accumulator according to the state of the art without any cooling device.

It emerges clearly from this FIG. 9 that, with the nebulization according to the invention, the accumulator temperature up to 100° C. drops much more rapidly. The cooling slope is thus three times higher for an accumulator on which a nebulization is applied compared to an accumulator according to the state of the art without any cooling device.

The invention is not limited to the examples which have just been described; characteristics of the examples illustrated can notably be combined with one another in variants that are not illustrated.

Other variants and enhancements can be envisaged without departing from the scope of the invention.

### LIST OF REFERENCES CITED

Xuning Fenga, et al. “Key Characteristics for Thermal Runaway of Li-ion Batteries” Energy Procedia, 158 (2019) 4684-4689.

1. The battery module, comprising:
an first accumulator comprising an electrochemical cell formed by a cathode, anode, and an electrolyte inserted between the cathode and the anode, a packaging being arranged to tightly contain the electrochemical cell;
a device forming a nebulizer comprising:
a tank comprising a liquid to be nebulized;
a piezoelectric element arranged in contact with a surface of the tank;
a temperature sensor suitable for measuring the temperature at a point within the module; and
an electronic control unit linked to the temperature sensor and to the piezoelectric element(s), the electronic unit being adapted to respectively detect, from a measurement made by the sensor, a threshold temperature being exceeded, and, when a detection is made, electrically power the piezoelectric element(s) so that the piezoelectric element(s) make(s) the surface of the tank vibrate in order to thus nebulize the liquid into microdroplets sprayed in the module.

2. The module of claim 1, wherein the electronic control unit is electrically powered by at least one accumulator of the module.

3. The module of claim 2, wherein the electronic control unit comprises a voltage converter configured for converting the direct voltage from an accumulator into the power supply voltage of the piezoelectric element(s).

4. The module of claim 1, wherein the electronic control unit comprises a first and a second distinct electronic circuit, the circuits being linked together by a relay,
wherein one of the two circuits is adapted to supply an electrical power supply to the other of the two circuits and detect, from the temperature measured by the sensor, a temperature exceeding the threshold temperature,
wherein the other of the two circuits is adapted to electrically power the piezoelectric element(s), and
wherein the relay is activated upon detection of the temperature.

5. The module of claim 1, comprising more than one of the nebulizer.

6. The module of claim 5, comprising a temperature sensor specific to each nebulizer or common to the nebulizers.

7. The module of claim 1, wherein the packaging of each accumulator being a housing, notably of cylindrical format.

8. The module of claim claim 7, wherein the nebulizer is incorporated in a nebulizer housing of form and dimensions identical to those of an accumulator housing, and
wherein the nebulizer housing is pierced with at least one through-hole to allow the microdroplets to be sprayed within the module to escape.

9. The module of claim claim 8, wherein the nebulizer housing is connected electrically in parallel with the housing(s) of the accumulator(s) of the module.

10. The module of claim 1, wherein the temperature sensor is a thermocouple or a pressure sensor or a chemical sensor.

11. The module of claim 1, wherein the tank is covered by a film designed to tear under a pressure of the microdroplets.

12. The module of claim 1, wherein the piezoelectric element is disposable.

13. The module of claim 1, wherein the piezoelectric element is configured to make the surface of the tank vibrate for a period in a range of from 5 to 10 seconds.

14. The module of claim 1, wherein the liquid to be nebulized is water, optionally glycolated and/or de-ionized, or a liquid based on dodecafluorooxepane.

15. The module of claim 1, wherein each accumulator is a Li-ion accumulator in which:
the negative electrode comprises graphite, lithium, and/or Li₄TiO₅O₁₂;
the positive electrode comprises LiFePO₄, LiCoO₂, and/or LiNi_{0.33}Mn_{0.33}Co_{0.33}^{O}₂.

16. A vehicle, comprising:
the battery module of claim 1.

17. The module of claim 1, comprising a first and a second of the accumulator.
